(19) United States
(12) Patent Application Publication
(10) Pub. No.: US 2011/0016524 A1
(43) Pub. Date: Jan. 20, 2011

(54) BLIND VERIFICATION OF COMPUTER FIRMWARE

(75) Inventor: Scott B. Guthery, Chestnut Hill, MA (US)

Correspondence Address: SHERIDAN ROSS PC, 1560 BROADWAY, SUITE 1200, DENVER, CO, 80202, US

(73) Assignee: ASSA ABLOY AB, Stockholm (SE)

(21) Appl. No.: 12/838,233

(22) Filed: Jul. 16, 2010

Related U.S. Application Data
(60) Provisional application No. 61/226,189, filed on Jul. 16, 2009.

(51) Int. Cl. G06F 21/00

(52) U.S. Cl. 726/22

(57) ABSTRACT

The means for using zero-knowledge protocols to provide assurance that the executable program instructions in a particular computing device are identical to given set of executable program instructions without revealing the executable program instructions themselves are disclosed.

### CROSS-REFERENCE TO RELATED APPLICATIONS

This Application claims the benefit of U.S. Provisional Application No. 61/226,189, filed Jul. 16, 2009, the entire disclosure of which is hereby incorporated herein by reference.

### FIELD OF THE DISCLOSURE

The present disclosure relates generally to computing systems and more specifically to verifying firmware in components of computing systems.

### BACKGROUND

An entity executing a software computer program wishes to gain assurance that the program's order code has not been altered. The entity providing the software does not wish to reveal the program's order code. Zero-knowledge authentication protocols can be used to satisfy the requirements of both parties.

As an example, a pilot of an airplane wishes to determine that the firmware running in a component of the airplane is the firmware placed in the component by its manufacturer. At the same time, the manufacturer of the component does not wish to make the firmware running in the component available to the owner of the airplane.

As another example, the holder of an integrated circuit card wishes to determine that the firmware running in a terminal into which the card is inserted is the code placed in the terminal by its manufacturer. At the same time the manufacturer of the terminal does not wish to provide the firmware in the terminal to the card relying party.

As a yet another example, the relying party of a certified integrated circuit card wishes to test that the executable program code in a card purchased from a card manufacturer is exactly the same as the executable program code examined by the authority that certified the card. At the same time, the manufacturer of the integrated circuit card does not wish to provide the relying party with the means to examine the executable program code in the card.

### SUMMARY

It is, therefore, one aspect of the present disclosure to provide a mechanism whereby the firmware (instructions, order code, executable code) in a computing device can be verified without revealing the firmware itself This allows relying parties to confirm that firmware which is executed by the computing device is identical to the firmware placed in the device by its manufacturer.

The Summary is neither intended nor should it be construed as being representative of the full extent and scope of the present disclosure. The present disclosure is set forth in various levels of detail and the Summary as well as in the attached drawings and in the detailed description of the disclosure and no limitation as to the scope of the present disclosure is intended by either the inclusion or non inclusion of elements, components, etc. in the Summary. Additional aspects of the present disclosure will become more readily apparent from the detailed description, particularly when taken together with the drawings.

### BRIEF DESCRIPTION OF THE DRAWINGS

FIG. 1 depicts a group of entities involved in the certification and verification process described herein;

FIG. 2 depicts an exemplary computing device in accordance with embodiments of the present disclosure;

FIG. 3 depicts an exemplary process for generating public parameters of a zero-knowledge authentication protocol in accordance with embodiments of the present disclosure; and

FIG. 4 depicts an exemplary process for verifying contents of programming code on a computing device in accordance with embodiments of the present disclosure.

### DETAILED DESCRIPTION

Embodiments of the disclosure will be illustrated below in conjunction with an exemplary computing system. Although well suited for use with, e.g., a system using computers, servers, and other computing devices, the disclosure is not limited to use with any particular type of computing or communication device or configuration of system elements. Those skilled in the art will recognize that the disclosed techniques may be used in any application in which it is desirable to verify firmware stored in a computing device.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form that are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

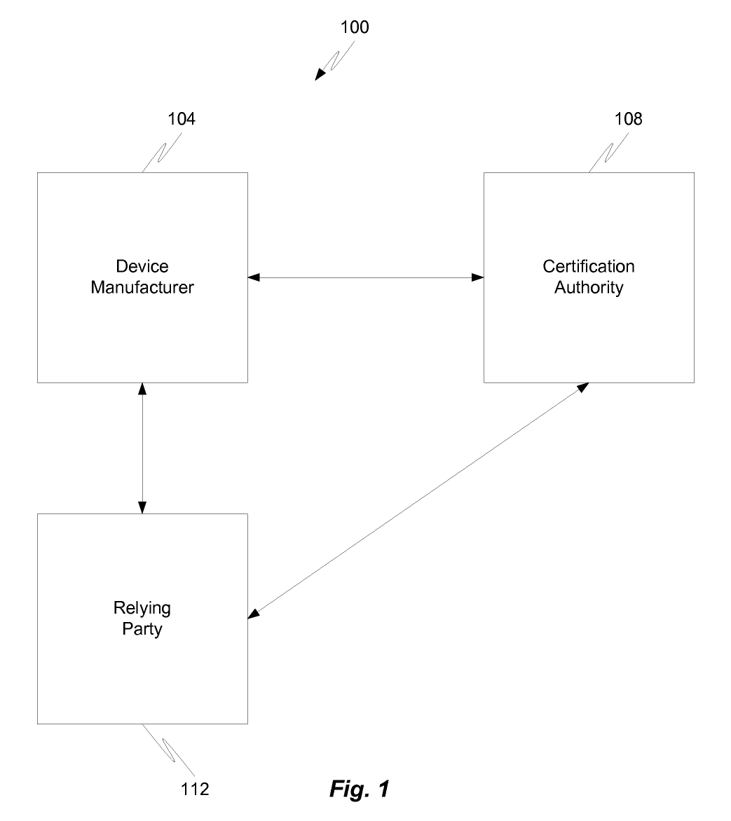

Referring initially to FIG. 1, a group of entities 100 concerned with the production, certification, and use of a computing device and the executable code stored thereon is depicted in accordance with embodiments of the present disclosure. The exemplary entities which may be involved in one or more phases of manufacturing a computing device, certifying code on a computing device, and verifying code on a computing device include a device manufacturer 104, a certification authority 108, and a relying party 112.

In some embodiments, the device manufacturer 104 is responsible for the manufacture and/or distribution of computing devices and the relying party 112 is a purchaser of such devices. In some embodiments, the manufacturer 104 is responsible for the complete manufacture of the computing device. In some embodiments, the manufacturer 104 is only responsible for manufacturing part of the computing device or providing the computing device with some amount of programming code.

In some embodiments, the relying party112 may correspond to an end user of the computing device or, in some embodiments, the relying party 112 may correspond to an intermediary (e.g., retailer, wholesaler, service provider, etc.) of the computing device. In either case, the relying party 112 is generally interested in certifying that the components of the computing device received from the manufacturer 104 are genuine and have not been tampered.

The manufacturer 104 can utilize a certification authority 108 which is a third-party to the manufacturer 104 that can provide certification credentials to the relying party 112 as will be discussed in further detail herein. The certification authority 108 can receive a computing device or contents of a computing device from the manufacturer 104 and generate a zero-knowledge authentication protocol, portions of which are shared with the relying party 112 thereby allowing the relying party 112 to verify contents of computing devices received from manufacturer 104.

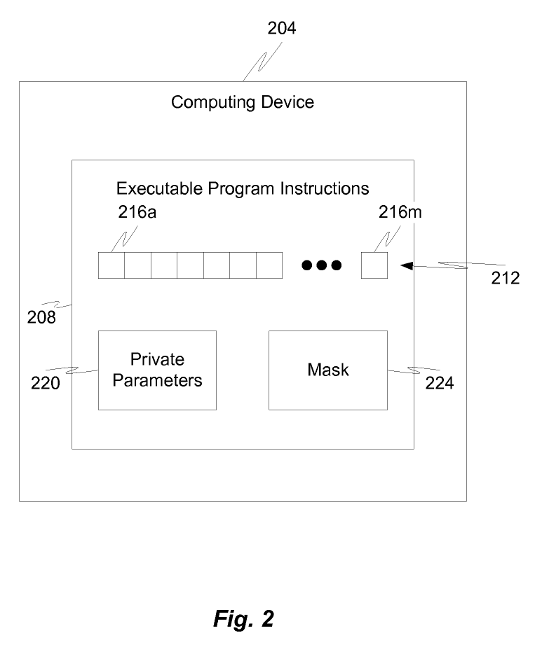

With reference now to FIG. 2, additional details of a computing device 204 are depicted in accordance with embodiments of the present disclosure. The computing device 204 may include executable program instructions 208 that are executable by the computing device 204. In some embodiments, the executable program instructions 208 are provided as firmware in the computing device 208. However, it may also be possible to provide the executable program instructions208 as software instructions in memory of the computing device 204, in which case the computing device 204 would also include a processor for executing the software instructions.

Exemplary types of computing devices 204 include, without limitation, integrated circuit cards, key fobs, integrated circuit card readers, integrated circuit card writers, control panels, computers, laptops, cellular phones, telephones, Personal Digital Assistants (PDAs), and the like. Accordingly, although not depicted, the computing device 204 may also include network and/or user interfaces which enable the computing device 204 to communicate with other computing devices and/or users.

The executable program instructions208 can be provided as a sequence of m bits 212, where m is generally greater than one. The sequence of bits 212 comprises a plurality of bits 216a-m that are the executable program instructions. The executable program instructions208 are executed by the computing device 204 during operation of the computing device 204. The content of the sequence of bits 212 will vary depending upon the nature and type of computing device 204.

As will be discussed in further detail below, the executable program instructions 208 may also include private parameters 220 and a mask 224 which is a sequence of m′ bits. The private parameters 220 and mask 224 may be provided on the computing device 204 by the certification authority 108 and may be utilized during implementation of the zero-knowledge authentication protocol.

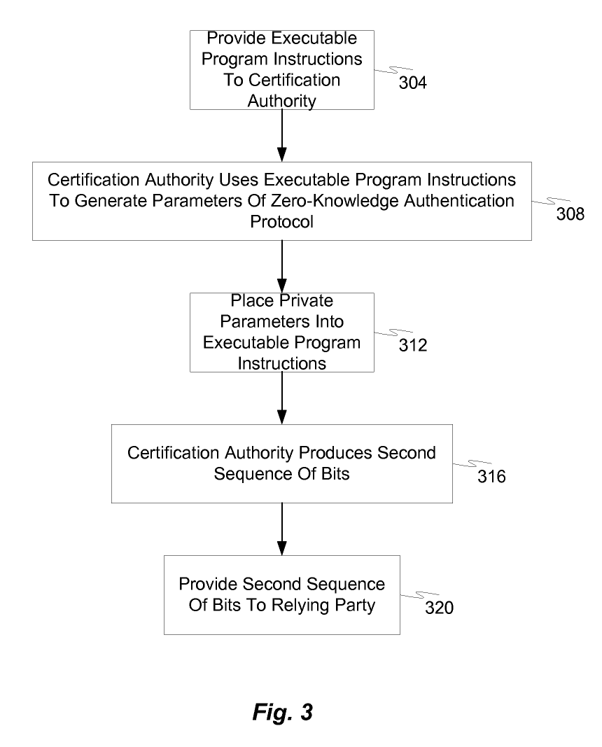

With reference now to FIG. 3 an exemplary process for generating public parameters of a zero-knowledge authentication protocol will be described in accordance with embodiments of the present disclosure. The method is initiated when the manufacturer 104 of the computing device 204 provides the certification authority 108 with the sequence of bits 212 comprising the executable program code C={cᵢ} that is to be placed in the computing device 204 (step 304). The executable program code 208 provided to the certification authority 108 also includes a sequence of m′ bits comprising the mask 224.

Once the certification authority 108 receives the programming code 208, the certification authority certifies the executable program instructions208 and uses the executable program instructions208 to generate the parameters of a zero-knowledge authentication protocol (step 308). The parameters generated by the certification authority in this step comprise private parameters 220, which are written to the computing device 204 as part of the programming code 208 (step 312). In some embodiments, the certification authority 108 may write the private parameters 220 to the computing device 204. In some embodiments, the certification authority 108 may communicate the private parameters 220 back to the device manufacturer 104 who writes the private parameters 220 to the computing device 204.

Thereafter, the certification authority 108 produces a second sequence of m bits B={bₗ, . . . , bₘ} (step 316). The second sequence of m bits may correspond to Boolean values computed by the certification authority based on the programming code 208 and mask 224. In some embodiments, the second sequence of m bits is the XOR of M across C.

Once generated, the second sequence of m bits is provided to the relying party 112 (step 320). The second sequence of m bits represents the public parameters of the zero-knowledge authentication protocol. In addition to providing these public parameters, the certification authority 108 may digitally sign the copy of the second sequence of m bits before providing it to the relying party 112. Additionally, the second sequence of m bits may be provided directly to the relying party 112 from the certification authority 108 or it may be provided to the relying party 112 via the device manufacturer 104.

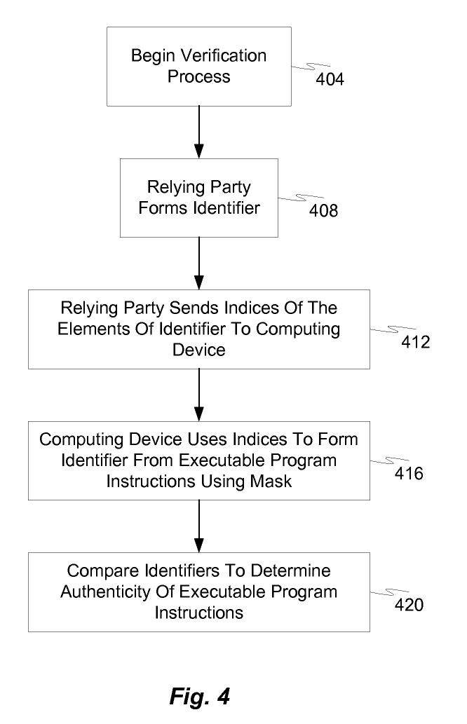

With reference now to FIG. 4, an exemplary process for verifying contents of programming code 208 on a computing device 204 will be described in accordance with embodiments of the present disclosure. The method is initiated when the relying party 112 determines that it wants to begin the verification process (step 404). Verification may be performed either remotely such as by exchanging verification messages over a communication network (e.g., SMS messages, Instant Messages, emails, etc.) between the computing device 204 and the relying party 112 or in the physical presence of the computing device 204. This determination may be made when the relying party 112 withes to conduct a test of the manufacturer's 104 assertion that a portion or all of the programming code 208 on the computing device 204 is exactly the same as the portion examined by the certification authority 108.

Once the verification process has begun, the relying party 112 forms an identifier I by selecting bits from the second sequence of m bits, B, (also referred to as the public parameters) such that the identifier satisfies the conditions of a zero-knowledge authentication protocol (step 408).

Thereafter, the relying party 112, as the verifier, conducts the zero-knowledge authentication protocol to authenticate the identifier by using the computing device 204 as the vehicle for proving the verification. In particular, during the protocol the relying party 112 sends the indices of the elements of the identifier to the computing device 204 (step 412). The computing device 204 uses the indices received from the relying party 112 to form a second identifier from the programming code 208 using the mask 224 (step 416). The second identifier formed from the programming code 208 and mask 224 is then compared to the originally provided identifier to determine whether the programming code 208 is authentic (step 420). If the originally provided identifier matches the second identifier computed from the programming code 208 and mask 224, then the executable program instructions in the device are 208 deemed to be identical to the executable program instructions examined by the certification authority whereas if the originally provided identifier does not match the second identifier, the executable program instructions in the device 208 are deemed to differ from the executable program instructions examined by the certification authority

Examples of the use of a some existing zero-knowledge protocol to implement the method are given below. It should be understood that the method of the disclosure is independent of the particular zero-knowledge protocol used for its realization.

Null Authentication Protocol

In the null protocol, when given an index i the computing device 204 returns bᵢ. While the manufacturer 104 may agree to have the second sequence of m bits, B, provided to the relying party 112, the manufacturer 104 may not be willing to have B published. Zero-knowledge authentication protocols are used to enable the relying party 112 to test the computing device's 204 ability to derive specific subsets of B from C without revealing and information about B or C.

Other mappings from C to B beside XOR of a mask 224 should be considered in order to, for example, block the insertion of rogue verification code that includes special handling of its own verification. A property of any such mapping is that bᵢ depend directly on the value of cᵢ and not, for example, be a closed-form or tabular function of i. For the sake of explanation, XOR will be used in the following discussion.

If XOR is used, the address of the first bit of the mask 224 should not be a multiple of the length of the mask 224, otherwise the location of the mask 224 in C will be revealed as a block of zeros.

Guillou-Quisquater Protocol

In this particular implementation, at step 308 the certification authority 108 produces the positive integer values n, v and s of Guillou-Quisquater zero-knowledge authentication protocol according to the following:

n−pq,

gcd(v,(p−1)(q−1))=1,

and

s=v⁻¹ mod(p−1)(q−1)

where p and q are random, large, unequal prime numbers. The certification authority 108 inserts n as the private parameter 220 s into the programming code 208.

During step 320, the certification authority 108 provides the relying party 112 with n and v along with the signed B.

When the relying party 112 wishes to test the program code 208 between bits k₁ and k₂, the relying party 112 selects k₁ and k₂ such that the following is between 1 and n−1

$$I = {\sum }_{i = {k}_{i}}^{{k}_{2}} {b}_{i} {2}^{i - {k}_{i}}$$

The relying party 112 then retrieves the following from the computing device 204:

x=r^{v} mod n

Where r is a random number integer generated by the computing device 204 for the purpose of validation.

The relying party 112 then picks a random integer e between 1 and v and sends the randomly selected integer e, along with k₁ and k₂ to the computing device 204. Once received, the computing device 204, at step 416, applies M to C between k₁ and k₂ to create I and computes the following:

w=I⁻⁸ mod n

and then further computes the following:

y=rw^{e} mod n

The values computed by the computing device 204 are then returned to the relying party 112. The relying party 112 then computes the following:

z=I^{e}y^{v} mod n

If z≠x, then the programming code 208 on the computing device 204 is determined not to be the executable cod examined by the certification authority 108 and validation is denied.

It should be noted that the bits {bᵢ} could be selected from anywhere in B. In this case, the indices of the selected bits, {lᵢ}ᵢ₌₁^{l}, would be sent to the computing device 204 for the computing device 204 to create I.

If an identifier I happens to be p or q, the method described above likely won't work because I wouldn't be invertible when the computing device 204 is applying the mask 224 to the programming code 208. This is a low likelihood event and can be avoided by putting constraints on k₂−k₁ such as having fewer bits than the bit-length of both p and q.

Fiat-Shamir Protocol

During the setup under this protocol, at step 308 the certification authority 108 selects a value k and produces the positive integer values n, {vᵢ}ᵢ₌₁^{k}, and {sᵢ}ᵢ₌₁^{k} of Fiat-Shamir-Feige zero-knowledge authentication protocol according to the following:

n=pq,

gcd(sᵢ,n)=1,

and

vᵢ=sᵢ² mod n

for all 1≦i≦k and where p and q are random large unequal prime numbers. The certification authority inserts the private parameters 220 n and {sᵢ} into the program code 208. The certification authority 108 then provides the public parameters k, n and {vᵢ} along with the signed B to the relying party 112.

During the execution, when the relying party 112 wishes to test the programming code 208 at bit locations L={lᵢ}ᵢ₌₁^{l} where 1≦l≦k. The relying party 112 continues by retrieving the following from the computing device 204:

x=sr²

where r is a random integer generated by the computing device 204 for the purpose of validation and s is selected at random from {−1,1} by the computing device 204.

The relying party 112 then sends L to the computing device 204 and then the computing device 204 applies M to C and using L produces {bₗ_{ᵢ}}. The computing device 204 then computes the following:

$$y = r {\prod }_{i = 1}^{l} {s}_{i}^{{b}_{{l}_{i}}} mod n$$

which is returned to the relying party 112. The relying party 112 then computes the following:

$$z = x {\prod }_{i = 1}^{l} {v}_{i}^{{b}_{{l}_{i}}} mod n$$

If y²≠±z mod n, then the programming code 208 on the computing device 204 is not the programming code 208 which was examined by the certification authority 108.

It should be noted that the sequence {lᵢ}ᵢ₌₁^{l} could be taken to be the sequence of bits between a k₁ and k₂. In this case, only k₁ and k₂ would need to be sent to the computing device 204 for the computing device 204 to create I.

Naccache Protocol

The Naccache zero-knowledge authentication protocol is a Fiat-Shamir-like scheme that uses Montgomery multiplication to compute the following for an odd n:

c=ab2^{|n|} mod n

Montgomery multiplication uses O(log n) memory space and takes the same amount of time to compute as the multiplication of a and b without the mod. The result is Fiat-Shamit authentication at the speed of non-modular computations.

The Montgomery multiplication function is:

f(a, b, n) {

c = 0;
for (i = 0; i <= |n|−1; i++) {

if(a[i] == 1) c = c + b;
if(c[0] == 1) then c = c + n;
c = c/2;

}
if (c >= n) then c = c − n;
return (c);

}

where x[i] denotes the i^{th} bit of x with x[0] being the least-significant bit.

Naccache refers to the following term as a parasite because it does not enter into the protocol computations:

D=2^{|n|}

In setting up the certification of the programming code 208, the certification authority 108 at step 308 selects a value k and produces the positive integer values n,{vᵢ}ᵢ₌₁^{k}, and {sᵢ}ᵢ₌₁^{k}, of Naccache zero-knowledge authentication protocol:

n=pq,

gcd(sᵢ,n)=1,

and

D³vᵢsⱼ²=1 mod n

for all 1≦i≦k and where p and q are random large unequal prime numbers. The certification authority 108 inserts n and {sᵢ} into the programming code 208 as the private parameters 220.

The certification authority 108 then provides the public parameters of k, n, and {vᵢ} along with the signed B to the relying party 112.

During the execution, when the relying party 112 wishes to test the programming code 208 at bit locations L={lᵢ}ᵢ₌₁^{l} where 1≦l≦k. The relying party 112 continues by retrieving the following from the computing device 204:

x=Dr² mod n=f(r,r)

where r is a random integer generated by the computing device 204 for the purposes of validating the programming code 208.

The relying party 112 then sends L to the computing device 204, which applies M to C and using L produces {bₗ_{ᵢ}} and then J={lᵢ|bₗ_{ᵢ}=1} of length m. The computing device 204 then computes the following:

$$y = {D}^{m} r {\prod }_{i = 1}^{l} {s}_{i}^{{b}_{{l}_{i}}} mod n$$

easily as

y=f(sⱼ_{₁},f(sⱼ₂, . . . , f(sⱼₘ) . . . ))

which is returned to the relying party 112.

The relying party 112 then computes the following:

$$z = r {\prod }_{i = 1}^{l} {v}_{i}^{{b}_{{l}_{i}}} mod n$$

easily as

z=f(vⱼ_{₁},f(vⱼ₂, . . . , f(vⱼₘ) . . . ))

If z≠x then the programming code 208 on the computing device 204 is determined to not be the programming code 208 which was examined by the certification authority 108.

It should be noted that the sequence {lᵢ}ᵢ₌₁^{l} could be taken to be the sequence of bits between a k₁ and k₂. In this case, only k₁ and k₂ would need to be sent to the computing device 204 for the computing device 204 to create I.

Implementations and Realizations

While the above-described flowcharts have been discussed in relation to a particular sequence of events, it should be appreciated that changes to this sequence can occur without materially effecting the operation of the disclosure. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this disclosure can be implemented on a special purpose computer in addition to or in place of the described access control equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as TPM, PLD, PLA, FPGA, PAL, a communications device, such as a server, personal computer, any comparable means, or the like. In general, any device capable of implementing a state machine that is in turn capable of implementing the methodology illustrated herein can be used to implement the various data messaging methods, protocols and techniques according to this disclosure.

Furthermore, the disclosed methods may be readily implemented in software. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the computer arts.

Moreover, the disclosed methods may be readily implemented in software that can be stored on a storage medium, executed on a programmed general-purpose computer with the cooperation of a controller and memory, a special purpose computer, a microprocessor, or the like. The system can also be implemented by physically incorporating the system and/or method into a software and/or hardware system, such as the hardware and software systems of a communications device or system.

It is therefore apparent that there has been provided, in accordance with the present disclosure, systems, apparatuses and methods for verifying executable instructions stored on computing devices. While this disclosure has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

What is claimed is:

1. A method, comprising:
receiving programming code for certification;
utilizing the programming code to generate parameters of a zero-knowledge authentication protocol, the generated parameters including at least one private parameter and at least one public parameter; and
providing the at least one public parameter to an entity to enable the entity to verify authenticity of the programming code.

2. The method of claim 1, further comprising:
incorporating the at least one private parameter into the programming code; and
distributing the programming code with the at least one private parameter to the entity.

3. The method of claim 2, further comprising:
receiving, at a computing device comprising the programming code with the at least one private parameter, selected indices computed based on the at least one public parameter;
using, by the computing device, the selected indices to compute an identifier; and
providing the identifier computed by the computing device to the entity.

4. The method of claim 3, wherein the identifier computed by the computing device is computed from the programming code using a mask.

5. The method of claim 4, wherein the selected indices are from an identifier computed by the entity using the at least one public parameter, the method further comprising:
comparing, by the entity, the identifier computed by the entity with the identifier computed by the computing device; and
determining, based on the comparison of the identifier computed by the entity with the identifier computed by the computing device, an authenticity of the programming code.

6. The method of claim 5, wherein the programming code is not exposed to the entity.

7. The method of claim 1, wherein the zero-knowledge authentication protocol comprises one of a null authentication protocol, a Guillou-Quisquater Protocol, a Fiat-Shamir Protocol, and a Naccache Protocol.

8. A method, comprising:
receiving a computing device comprising programming code stored thereon;
receiving at least one public parameter generated by a certification authority, the at least one public parameter generated by applying a zero-knowledge authentication protocol to the programming code;
providing at least one selected index to the computing device;
receiving a first identifier from the computing device, the first identifier generated by the computing device in response to receiving the at least one selected index; and
comparing the first identifier with a second identifier to determine an authenticity of the programming code.

9. The method of claim 8, wherein the second identifier is computed based, at least in part, on the at least one public parameter generated by the certification authority.

10. The method of claim 8, wherein the first identifier is computed from the programming code and a mask thereof, both of which are stored in the computing device.

11. The method of claim 8, wherein the computing device comprises at least one of an integrated circuit card, a key fob, an integrated circuit card reader, an integrated circuit card writer, a control panel, a computer, a laptop, a cellular phone, a telephone, and a Personal Digital Assistant.

12. The method of claim 8, wherein the programming code is provided on the computing device as firmware.

13. The method of claim 8, wherein the programming code is provided on the computing device as software.

14. The method of claim 8, wherein the zero-knowledge authentication protocol comprises one of a null authentication protocol, a Guillou-Quisquater Protocol, a Fiat-Shamir Protocol, and a Naccache Protocol.

15. A computing device, comprising:
programming code containing a sequence of executable bits and a mask, wherein the computing device is configured to receive selected indices and compute an identifier with the selected indices, wherein the selected indices are computed based on at least one public parameter determined by applying a zero-knowledge authentication protocol with the programming code as input.

16. The device of claim 15, wherein the identifier is computed from the programming code using a mask.

17. The device of claim 15, wherein the programming code is firmware.

18. The device of claim 15, wherein the identifier is computed by using at least one private parameter that was also determined by applying the zero-knowledge authentication protocol with the programming code as input.

19. The device of claim 15, wherein the zero-knowledge authentication protocol comprises one of a null authentication protocol, a Guillou-Quisquater Protocol, a Fiat-Shamir Protocol, and a Naccache Protocol.

20. The device of claim 15, wherein the programming code is maintained securely by the computing device.
